(19) United States
(12) Patent Application Publication
(10) Pub. No.: US 2006/0235820 A1
(43) Pub. Date: Oct. 19, 2006

(54) Relational query of a hierarchical database

(75) Inventors: Robert Aloise Hoth, Rochester, MN (US); John Williams Miller, Duluth, GA (US); Joaquin Ramirez, San Jose, CA (US)

Correspondence Address: IBM CORPORATION, IPLAW IQ0A/40-3, 1701 NORTH STREET, ENDICOTT, NY, 13760, US

(73) Assignee: International Business Machines Corporation, Armonk, NY (US)

(21) Appl. No.: 11/106,412

(22) Filed: Apr. 14, 2005

(51) Int. Cl. G06F 17/30

(52) U.S. Cl. 707/1

(57) ABSTRACT

Relational queries to a hierarchical database having data tables are rapidly processed. A bridging table is created to transform a many to many relationship into a plurality of one to many relationships. The bridging table is stored on a custom semiconductor chip which parses the query and determines by use of the bridging table which records in the data tables match the query using a custom data algorithm stored on the semiconductor chip. For each match, a pointer to a target record in the hierarchical database is stored. Instructions executed on the custom chip read the pointers or the target records and transfer these to the query requester.

### TECHNICAL FIELD

The invention relates to methods and systems for accessing a hierarchical database and particularly to accessing these databases using a relational query. Even more particularly the invention relates to mechanisms for rapidly accessing a hierarchical database after receiving a relational query from a requester and rapidly returning those target records identified by the relational query to the requester.

### BACKGROUND ON THE INVENTION

Many companies and governments use hierarchical databases for capture and retrieval of data associated with transactions, particularly business transactions performed by the company or governmental body. A hierarchical database uses a hierarchical schema for storing information known as the parent/child model. A hierarchical schema may be represented as a tree structure, where each parent node may have a plurality of child nodes, while each child node may have only one parent node.

Another commonly used database is the relational database which is a tabular database having the data defined so that it can be reorganized and accessed in a number of different ways. In a relational database, data records are maintained in data tables or collection of rows all having the same columns. Each row is a data record and each column holds information of a particular type of data for the data records. Data records may be indexed using unique indices or keys that join different data records in different tables together.

Relational databases are particularly useful because the information stored therein may be accessed using a relational query language. One such query language, SQL (Structured Query Language) SQL IS A TRADEMARK OF INTERNATIONAL BUSINESS MACHINES CORPORATION, is widely used and understood by relational database users.

Unfortunately, asking fundamental relational questions of a hierarchical database is not possible without providing additional capabilities beyond what is normally available. For example, many companies and other organizations support their operations by maintaining two databases, a hierarchical database and a relational one, along with associated support staffs. This approach is costly and cumbersome to maintain.

Hoth et al. in U.S. patent application Ser. No. 2004/0030716 A1 describe a method for providing a relational schema in a hierarchical database. A bridging table is created to describe and document the interconnections between entities in a hierarchical database. The Hoth patent application noted above is incorporated herein by reference in its entirety.

While the method described by Hoth does provide the desired capability, it is often slow in response time due to the overhead required in forming the bridging table, and in delivering query responses back to the client.

An improvement in query response time is needed to satisfy customer demands for query capability with their hierarchical databases.

### OBJECTS AND SUMMARY OF THE INVENTION

It is therefore a principal object of the present invention to provide a method of rapidly providing response data from a hierarchical database to a client query, presented in a relational query language.

It is another object to provide a system having such a rapid response query capability.

These and other objects are attained in accordance with one embodiment of the present invention wherein there is provided a method of querying a hierarchical database, comprising the steps of defining a plurality of many to many relationships for the hierarchical database, creating a bridging table having records to transform the many to many relationships between a first and second entity into one to many relationships between the first entity and the bridging table, and one to many relationships between the bridging table and the second entity, storing the bridging table in a memory in an integrated circuit chip, receiving a relational query from a requester, parsing the relational query by instructions executed on the integrated circuit chip, accessing each of the records in the bridging table and if the each record meets the query, storing a pointer to a target record in the hierarchical database, and reading all the target records or the pointers and transferring the read target records or the pointers to the requester.

In accordance with another embodiment of the invention, there is provided a system for querying a hierarchical database comprising means for defining a plurality of many to many relationships for the hierarchical database, an integrated circuit chip having a memory and an instruction processor, means for creating a bridging table stored on the integrated circuit chip, the bridging table having records to transform the many to many relationships between a first and second relationship into one to many relationships between the first relationship and the bridging table, and one to many relationships between the bridging table and the second relationship, means for receiving a relational query from a requester, means for parsing the relational query by instructions executed by instruction processor on the integrated circuit chip, means for accessing each of the records in the bridging table and if the each record meets the query, storing a pointer to a target record in the hierarchical database, and means for reading all the target records or the pointers and transferring the read target records or the pointers to the requester.

### BRIEF DESCRIPTION OF THE DRAWINGS

FIG. 1 is a flowchart illustrating steps of the present invention;

FIG. 2 is a flowchart depicting a method for providing a bridging table;

FIG. 3 is a functional block diagram of a semiconductor chip adapted to the present invention; and

FIG. 4 is a flowchart illustrating reading of target records.

### BEST MODE FOR CARRYING OUT THE INVENTION

For a better understanding of the present invention, together with other and further objects, advantages and capabilities thereof, reference is made to the following disclosure and the appended claims in connection with the above-described drawings.

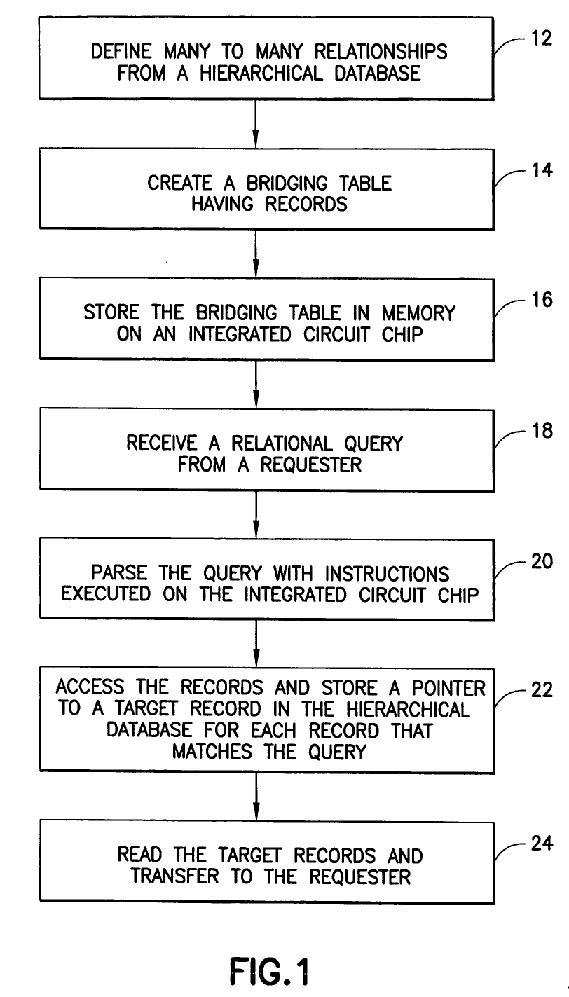

In FIG. 1, there is shown a flowchart depicting the steps needed to carry out an improved method of querying a hierarchical database in accordance with the present invention. A plurality of many to many relationships are defined for the hierarchical database in step 12. As noted above a hierarchical database supports one to many relationships. Any type of hierarchical database may be used such as the databases used in the LOTUS NOTES software product (LOTUS NOTES is a registered trademark of Lotus Development Corporation of Cambridge, Massachusetts).

The many to many relationships from step 12 must therefore be transformed into one to many relationships in order to be compatible with the hierarchical database structure. One method of transformation is through use of a bridging table created in step 14. The bridging table is structured so that the many to many relationships are replaced, for example, with a plurality of one to many relationships between a first entity and the bridging table, and a second plurality of one to many relationships between the bridging table and a second entity.

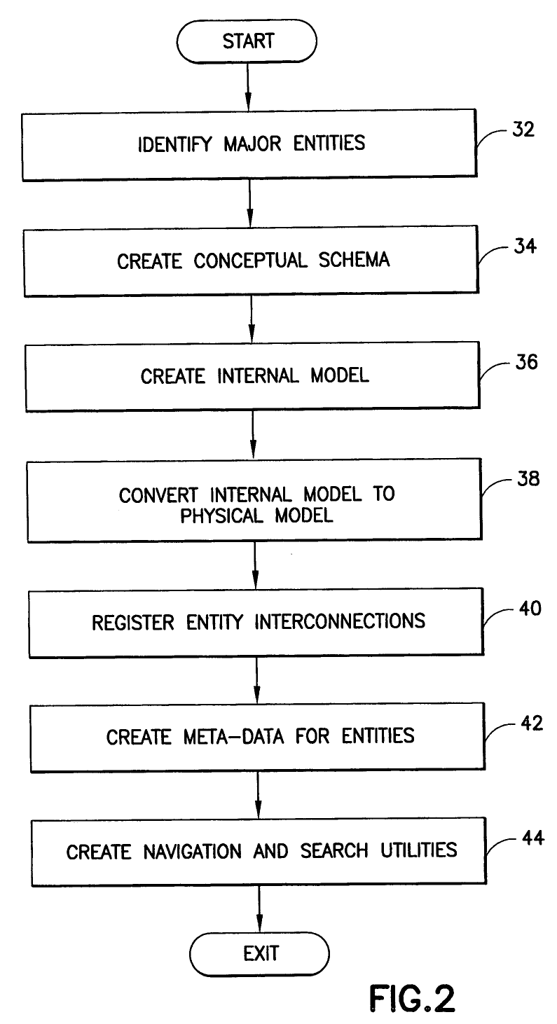

FIG. 2 is a flowchart depicting such a transformation process. Major entities in the relationships are identified in step 32. A conceptual schema is created in step 34 to represent how the different identified entities relate among each other. The conceptual schema therefore represents an entity relationship diagram. In step 36, an internal model is created from the conceptual schema. The internal model identifies entities having many to many relationships, which must be transformed for use in the hierarchical database.

The internal model is converted into a physical model in step 38 adapted to the requirements of the underlying database. If, for example, the underlying database is part of LOTUS NOTES, forms and views may be created. Data may then be entered into the forms to populate corresponding tables to create the underlying data structure. Data may also be stored in underlying data tables.

In step 40, interconnections between interconnected entities are registered using a joining table. The joining table may comprise paths between the entities identified in step 32 including those paths between entities that are interconnected using a bridging table. Each entry in the joining table is derived from the internal model created in step 36. Each entry in the joining table defines how data associated with a specific entity may be retrieved departing from another entity.

In step 42, meta-data is created for each entity, defining the types of data that may be extracted from a corresponding entity. Data may be retrieved for displaying or presenting to a user. Generating the meta-data comprises generating a table documenting the entities, the interconnection between the entities, or the data flow between the entities.

All of the steps listed above for FIG. 2 are described in further detail in U.S. patent application Ser. No. 2000/0030716 A1 by Hoth et al. In step 44, components for searching and retrieving data from the hierarchical database are created. This step is described below in connection with FIGS. 1, 3, and 4.

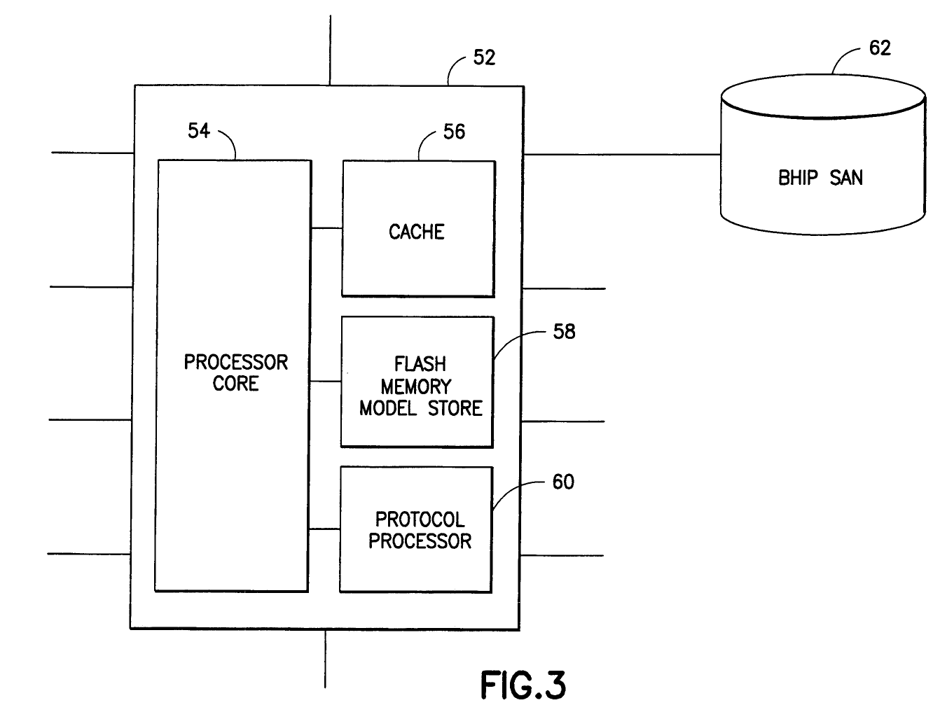

In FIG. 3, there is shown custom semiconductor chip 52, having processor core 54, cache 56, flash memory 58, and server protocol processor 60. External storage 62 in the form of a storage area network is attached to and accessible from semiconductor chip 52. Other elements may be present on semiconductor chip 52 for other purposes without departing from the present invention

Processor core 54 includes an instruction processor for executing programming instructions. For example, processor core may execute instructions for parsing a relational query, or instructions for reading target records. The instructions may be stored on semiconductor chip 52. For example, instructions may be stored in cache 56, or flash memory 58, or within the processor core 54 itself. Furthermore, instructions may also be stored on storage 62 and retrieved as needed to practice the present invention. Frequently executed instructions are stored in cache 56, or within processor core 54 itself. Less frequently executed instructions may be stored in flash memory 58 or storage 62. Those of ordinary skill in the semiconductor design arts will recognize such tradeoffs and optimizations in data storage may be made without departing from the spirit of the present invention.

Semiconductor chip 52 may be mounted singly or in combination with other chips on a conventional or special single or multi-chip, chip carrier. The chip carrier is mounted in a preferred embodiment on a plug-in card for positioning in a mainframe box. The plug-in card preferably is adapted to provide attachment to an array of hard drives via ribbon cable or other means, and includes attachment to an I/O bus within the mainframe box.

Returning to FIG. 1., the bridging table is stored in step 16 in memory on the customer integrated circuit chip of FIG. 3. In a preferred embodiment, the bridging table is stored in cache 56 or flash memory 58. Data table addresses, the meta data and table interconnections may also be stored in cache 56 or flash memory 58.

In step 18, a relational query is received from a requester. The requester may be a user who formulates his relational query using the SQL query language. Users typically expect to be able to ask business intelligence questions using a relational query to a database. The query may be entered at a workstation on which the hierarchial database, custom semiconductor chip and all other software and hardware elements of the present invention are self-contained. More typically, though, the database is located on a server computer and the user enters his query at a remotely connected workstation, terminal device, laptop computer, palm device, cellular telephone, or other portable device.

The relational query travels across the interconnection to custom semiconductor chip 52 where it is parsed in step 20 by instructions executed in processor core 54. Parsing allows the query to be matched to records in the stored bridging table or data table in step 22. For each record which meets the parsed query, a pointer is stored to a target record in the hierarchial database. Pointers may be stored anywhere on semiconductor chip 52. For example, the pointers may be stored in a stack in cache 56 or flash 58 memory of semiconductor chip 52. Pointers may also be stored external to chip 52, e.g., in storage area network (SAN) 62, or in any storage media location. Instructions for accessing the bridging and data table records and comparing each to the parsed query may be executed in processor core 54.

In step 24, the contents of the stack, e.g., the pointers from step 22, may be returned to the requester. In step 24, processor core 54 may also read the target records from the hierarchial database and transfer these records to the requester. The hierarchial database may be located on a hard drive or on SAN 62. When the requester is remotely located, the target records would normally be sent back to the requesting device, however, this is not required. Those skilled in the art will recognize that the target records, once retrieved, may be further processed into a report and that the report or target records themselves can be transferred to the requester at any desired location.

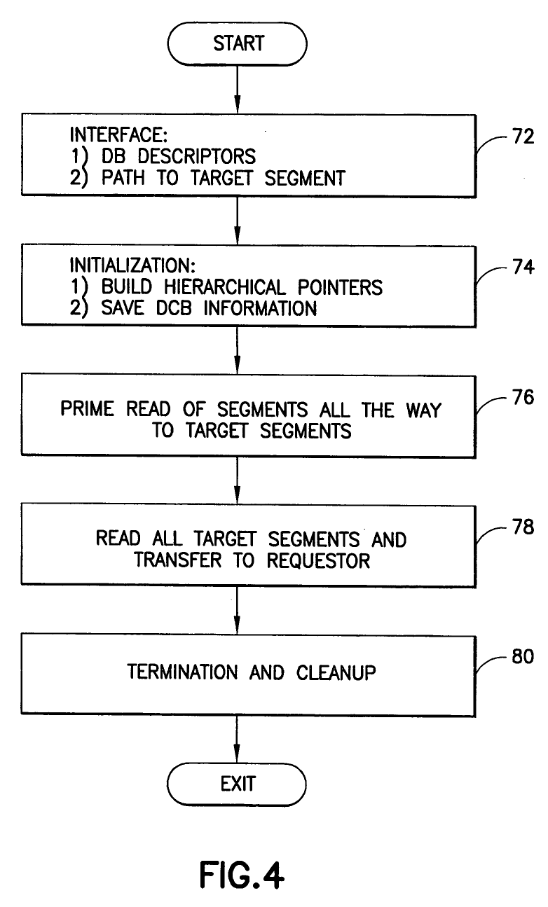

Reading the volumes of target records from the hierarchical database can be a time consuming, performance limiting operation. Consequently, a customized addressing algorithm as shown in FIG. 4 may be used in steps 22 and 24. The algorithm may be used on any hierarchical structure by providing database descriptors in step 72. The record to be read is based on the target record itself together with its path as provided in step 72. The database descriptors are obtained and interpreted to provide the path to the target segment.

In step 74, paths are set up to link to the hardware where the database is located. For example, if the database is located on a hard drive, then communication links to the hard drive control unit are initialized in step 74.

In step 76, a hierarchical read is done all the way to the target segments using the data table addresses, bridging table, meta data, and table interconnections described above.

In step 78, the target segments are transferred to the requestor. As noted for step 24, the pointers may alternatively be returned to the requester. In step 80, the addressing algorithm terminates.

While there have been shown and described what are at present considered to be the preferred embodiment of the invention, it will be obvious to those skilled in the art that various changes and modifications may be made therein without departing from the scope of the invention as defined by the appended claims.

What is claimed is:

1. A method of querying a hierarchical database, comprising the steps of:
defining a plurality of many to many relationships for said hierarchical database;
creating a bridging table having records to transform said many to many relationships between a first and second entity into one to many relationships between said first entity and said bridging table, and one to many relationships between said bridging table and said second entity;
storing said bridging table in a memory in an integrated circuit chip;
receiving a relational query from a requester;
parsing said relational query by instructions executed on said integrated circuit chip;
accessing each of said records in said bridging table and if said each record meets said query, storing a pointer to a target record in said hierarchical database; and
reading all said target records or said pointers and transferring the read target records or the pointers to said requester.

2. The method of claim 1, wherein said many to many relationships are between entities including an interconnection between a specific one of said entities and another of said entities.

3. The method of claim 2, further comprising the step of creating using the bridging table, a joining table describing said interconnection between said specific one of said entities and said another of said entities.

4. The method of claim 1, wherein said instructions are stored on said interconnection chip.

5. The method of claim 1, wherein said relational query is an SQL query.

6. The method of claim 1, wherein said target records are read using a customized addressing algorithm.

7. A system for querying a hierarchical database comprising:
means for defining a plurality of many to many relationships for said hierarchical database;
an integrated circuit chip having a memory and an instruction processor;
means for creating a bridging table stored on said integrated circuit chip, said bridging table having records to transform said many to many relationships between a first and second relationship into one to many relationships between said first relationship and said bridging table, and one to many relationships between said bridging table and said second relationship;
means for receiving a relational query from a requester;
means for parsing said relational query by instructions executed by said instruction processor on said integrated circuit chip;
means for accessing each of said records in said bridging table and if said each record meets said query, storing a pointer to a target record in said hierarchical database; and
means for reading all said target records or said pointers and transferring the read target records or said pointers to said requester.

8. The system of claim 7, wherein said many to many relationships are between entities including an interconnection between a specific one of said entities and another of said entities.

9. The system of claim 8, further comprising means for creating using the bridging table, a joining table describing said interconnection between said specific one of said entities and said another of said entities.

10. The system of claim 7, wherein said instructions are stored on said interconnection chip.

11. The system of claim 7, wherein said relational query is an SQL query.

12. The system of claim 7, wherein said target records are read using a customized addressing algorithm.
